(19) United States
(12) Patent Application Publication
(10) Pub. No.: US 2023/0065228 A1
(43) Pub. Date: Mar. 2, 2023

(54) APPARATUS, SYSTEM, AND METHOD FOR SHUTDOWN OF INTERNAL COMBUSTION ENGINE BY VALVE DEACTIVATION

(71) Applicant: Cummins Inc., Columbus, IN (US)

(72) Inventors: Simon Anthony Burge, Rugby (GB); Simon Andrew Wormald, Warwickshire (GB); Kieran J. Richards, West Haddon (GB); Prasad Mathew Tharayil, Columbus, IN (US)

(21) Appl. No.: 18/049,779

(22) Filed: Oct. 26, 2022

Related U.S. Application Data
(63) Continuation of application No. PCT/US2021/030575, filed on May 4, 2021.
(60) Provisional application No. 63/028,155, filed on May 21, 2020.

(51) Int. Cl. F02D 13/06; F02D 41/14; F02D 17/04; F02D 41/00

(52) U.S. Cl. CPC F02D 13/06; F02D 17/04; F02D 41/0007; F02D 41/144

(57) ABSTRACT

An apparatus, method, and/or system is provided for conducting an engine shutdown in a circumstance of a runaway engine event. In a condition where an uncontrolled fuel source is present in the ambient air, there may be a risk of a runaway engine condition in an internal combustion engine. Air taken into an intake system of the engine may include an undesired or uncontrolled combustible component. The method, apparatus, and/or system includes steps, control systems, devices, and mechanisms to prevent opening of at least one intake valve or exhaust valve of at least one cylinder of the engine to stop combustion in the chamber, in response to a condition indicating a possible runaway engine event. The indicator may include an engine overspeed condition, or presence of the combustible component in the intake air.

### CROSS-REFERENCE TO RELATED APPLICATIONS

The present application is a continuation of PCT Patent Application No. PCT/US21/30575 filed on May 4, 2021, which claims the benefit of the filing date of U.S. Provisional Application Ser. No. 63/028,155 filed on May 21, 2020, each of which is incorporated herein by reference in its entirety.

### TECHNICAL FIELD

The present disclosure relates generally to internal combustion engines, and more particularly but not exclusively to an apparatus, system, and method for achieving shutdown of operation of an internal combustion engine in a circumstance where the engine is taking in fuel in its intake air from an uncontrolled source, possibly leading to a dangerous and undesired runaway engine condition.

### BACKGROUND

In some conditions where internal combustion engines operate, an uncontrolled source of fuel may be present. For example, the ambient environment may contain combustible or explosive components. Flammable gases like natural gas or other hydrocarbon vapors may be found in oilfields or gas fields, and combustible dust particles may be found in mining environments. Also, some engine operating environments may include leaked engine fuels in vapor form, such as gasoline or diesel fuel.

An internal combustion engine operating in such an environment may take in the combustible or explosive components in its intake air, and the components may then be combusted in the engine as a fuel. The combustion of such components introduced with the intake air may lead to a dangerous condition in the nature of a “runaway” engine where operational control of the engine is compromised or lost due to this uncontrolled source of fuel introduced with the intake air. The engine may run in an “overspeed” condition where engine speed exceeds the commanded engine speed. The engine may continue to operate by combusting fuel from the uncontrolled source even after normal engine shutdown has been attempted.

Current solutions for stopping such undesirable runaway engine conditions have included air shut-off valves positioned to obstruct the air intake passage to prevent intake air from entering the combustion chambers of the engine. Such air shut-off valves have employed “puck” or “guillotine” type shut-off valves. Such shut-off valves have the drawback of adding weight to the engine and complexity to the engine design. Such shutoff valves also have the drawback of requiring manual resetting by a technician after the shut-off valve has been deployed. The manual resetting process requires engine downtime, as well as entailing costs and risks associated with the resetting process. Current solutions for stopping runaway engine conditions also have involved control strategies for the intake valve and the exhaust valve of the combustion chamber of cylinders of the engines. The strategies rely on holding one or more of the intake or exhaust valves at least partly open using valve actuators, which may interfere with other operational objectives and parameters. Improvements are still needed in effective control of engines in runaway conditions.

### SUMMARY

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

In an aspect of the present disclosure, an internal combustion engine includes at least one cylinder in the nature of an internal combustion chamber, and at least one intake valve controlling flow of intake air into the chamber through an intake port, and at least one exhaust valve controlling flow of exhaust gas through an exhaust port out of the chamber. Disclosed is an apparatus, method, and/or system for use in a condition where intake air includes an undesired or uncontrolled combustible component. In a condition where the intake air includes such a combustible component that may lead to an undesired runaway or overspeed engine condition, the method, apparatus, and/or system may comprise steps, control systems, devices, or mechanisms to prevent opening of at least one intake valve or exhaust valve of at least one cylinder of the engine to stop combustion in the chamber, in response to an engine overspeed condition or a presence of the combustible component in the intake air. Stopping combustion in a sufficient number of cylinders of the engine results in an engine shutdown needed to stop a runaway engine condition.

### BRIEF DESCRIPTION OF THE DRAWINGS

FIG. 1 is a diagrammatic view of an internal combustion engine system.

FIG. 2 is a transverse cross-sectional view of a portion of the engine of FIG. 1 having a cam-actuated valve train.

FIG. 3 is partial cross-sectional view of a portion of an apparatus for preventing opening of an intake valve according to an aspect of the invention, shown in a state where the apparatus is not engaged.

FIG. 4 is a partial cross-sectional view of a portion of the apparatus of FIG. 3, showing the apparatus in an engaged state.

FIG. 5 is a flow diagram illustrating certain aspects of an exemplary method according to an aspect of the invention.

FIGS. 6A-6B show another flow diagram illustrating certain aspects of an exemplary method according to an aspect of the invention.

FIG. 7 is a schematic diagram illustrating certain aspects of a control method according to an aspect of the invention.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

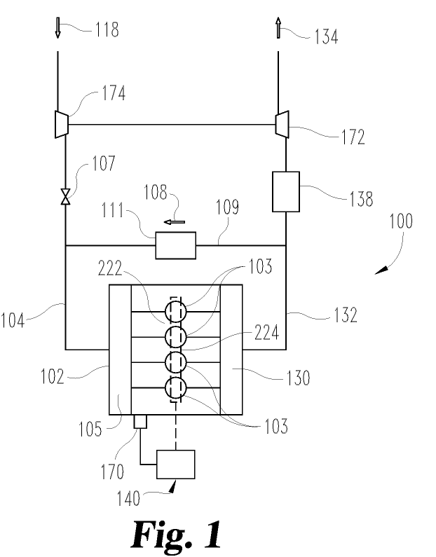

Referencing FIG. 1, a system 100 is depicted having an engine 102. The engine 102 is an internal combustion engine of any type, and may include a stoichiometric engine, a diesel engine, a gasoline engine, an ethanol engine, and/or a natural gas engine. The engine may combust more than one type of fuel, for example, the engine may combust natural gas fuel and diesel fuel. The engine may be a hybrid engine using power generated by internal combustion in addition to power supplied from other sources such as an electric motor. In certain embodiments, the engine 102 includes a lean combustion engine such as a lean burn gasoline engine, or a diesel cycle engine. The engine 102 includes a number of cylinders 103. The number of cylinders 103 may be any number suitable for an engine. In the illustrated embodiment, the system 100 includes an inline 4 cylinder arrangement for illustration purposes, but V-shaped arrangements and other numbers of cylinders are also contemplated.

In the system 100, exhaust flow 134 produced by cylinders 103 is provided to an exhaust manifold 130 and outlet to an exhaust passage 132. System 100 may include and exhaust gas recirculation (EGR) passage 109 to provide an EGR flow 108 that combines with an air intake flow 118 at intake manifold 105 or at a position upstream of an intake manifold 105 (as shown). Intake manifold 105 provides a charge flow to the cylinders 103 including the intake flow 118, and, if provided, EGR flow 108, which may be cooled by an EGR cooler 111. Intake manifold 105 is connected to an intake passage 104 that may include an intake throttle 107 to regulate the charge flow to cylinders 103. Intake passage 104 may also include an optional compressor 174 to compress the intake air flow.

In embodiments, a turbocharger may be provided that includes a turbine 172 in exhaust passage 132 that is operable via the exhaust gases to drive compressor 174 in intake passage 104. Exhaust passage 132 may include an aftertreatment system 138 upstream and/or downstream of turbine 172 in exhaust passage 132 that is configured to treat emissions in the exhaust gas.

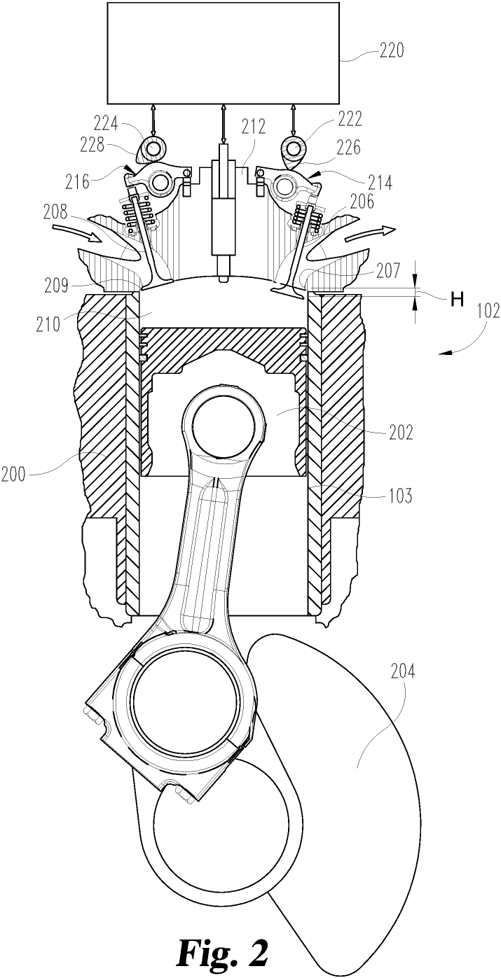

Referring to FIG. 2, a typical multi-cylinder engine 102 has an engine block 200 with multiple cylinders 103, and a piston 202 in each cylinder that is operably attached to a crankshaft 204. There is also at least one exhaust valve 206 and at least one intake valve 208 that control passage of intake air and/or exhaust gases into and out of a combustion chamber 210 formed inside each cylinder 103, through intake and exhaust ports. The typical engine 102 operates on a four-stroke cycle that sequentially includes an air intake stroke, a compression stroke, a power stroke, and an exhaust stroke. As used herein, one cycle of the cylinder or engine occurs at the completion of these four strokes.

Referring further to FIG. 2, the system 100 may include a valve actuation mechanism 220 that is configured to provide or switch between various lift profiles for activation and/or deactivation of the opening and closing of the intake valves 208 and the exhaust valves 206 of one or more of the cylinders 103 in response to engine operation conditions and/or commands from controller 140. Valve actuation mechanism 220 may include hardware mounted in a head 212 of engine 102 such as valve opening and closing mechanisms 214, 216. The valve actuation mechanism 220 may include, or operate in response to, control algorithms that are internal to the mechanism 220 or the controller 140. The valve actuation mechanism 220 may also comprise a hydraulic subsystem (not shown) that supplies pressurized oil from an engine oil pump (not shown) to each valve opening mechanism 214, 216 to actuate the mechanisms.

A valve train may be operable to open the plurality of exhaust valves 206, the plurality of intake valves 208, or both, depending upon the engine design. A typical valve train may be comprised of the camshafts 222, 224 (or in another embodiment a single camshaft) and the plurality of valves 206, 208, each of which are biased in a closed position in a port by means of being spring-mounted in the head 212. The camshaft 222, 224 may be a rod that rotates around its longitudinal axis. Each camshaft 222, 224 has a cam 226, 228, respectively, that corresponds to one of the valves 206, 208. Cams 226, 228 are typically cut into the respective camshaft 222, 224 such that they are eccentric to the axis of rotation of the respective cam shaft 222, 224. Each cam 226, 228 has an eccentric portion and a portion that is concentric to the longitudinal axis. Each cam 226, 228 is in physical contact with the respective valve opening mechanism 214, 216, which may, in typical arrangements, be comprised of a lifter and a locking pin mechanism. The valve opening mechanism 214, 216 is in physical contact with a cam following element of a respective valve 206, 208. The cam following element may be constituted as a cam follower attached to a pushrod of the valve. The rotation of the camshaft 222, 224 causes each valve 206, 208 to open from its respective seat 207, 209 when the position of the camshaft is such that the eccentric portion of the lobe is in contact with the respective valve opening mechanism 214, 216, which in turn will press against the cam follower, which in turn moves the pushrod, and in turn, moves the valve to lift it from its seat. In FIG. 2, exhaust valve 206 is shown lifted from seat 207 by a distance corresponding to a first height H, and intake valve 208 is not lifted, being positioned against its seat 209. Both valves 206, 208 may be lifted from their respective seats simultaneously to provide an overlap in valve opening.

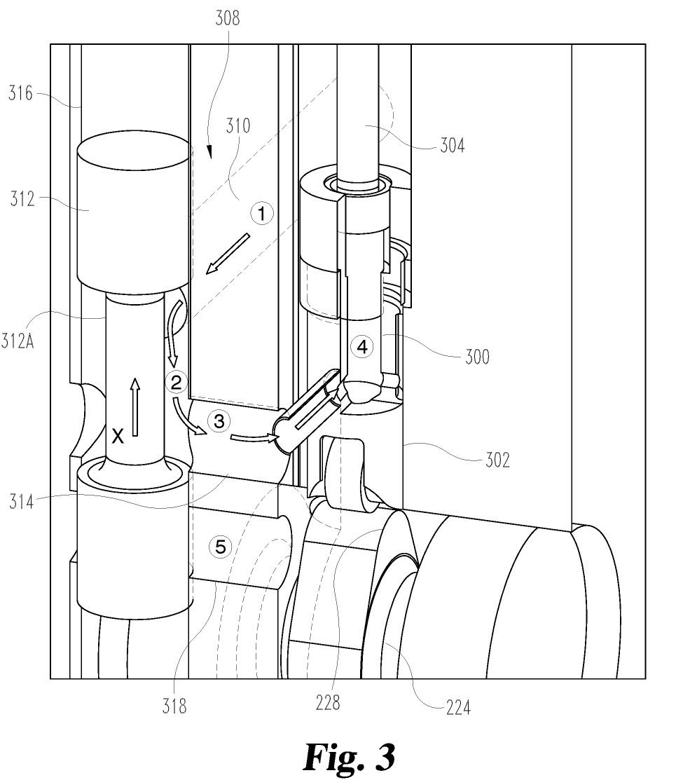

FIG. 3 is partial cross-sectional view of a valve deactivation system comprising an actuator. The actuator may be engaged for preventing opening of an intake port by deactivating the intake valve, according to an embodiment of the invention. It will be appreciated that a corresponding actuator construction may be adopted for preventing opening of an exhaust port by deactivating an exhaust valve. It is noted that the arrangement of the intake valve 208 with respect to the cam 228 in FIG. 3 is inverted from the arrangement shown in FIG. 2.

As seen in FIG. 3, the intake valve 208 may comprise a pushrod portion, here constituted as pushrod 304, positioned between a sealing end (not shown in FIG. 3) of the intake valve 208 and the cam follower 302. In the condition shown in FIG. 3, the cam 228 is in its peak lift condition, pressing on the cam follower 302 in an upward direction, thus pressing the pushrod 304 upwardly so as to hold the sealing end (not shown) of the intake valve 208 in its open position, away from its seat in the intake port.

In an embodiment of the apparatus or system according to the invention, the cam follower 302 of the intake valve 208 may include a collapsible element 300. In FIG. 3, the collapsible element is in the nature of a collapsible hydraulic element, shown here in its expanded state. The hydraulic element 300 is held in its expanded state by being filled with pressurized oil fed into the hydraulic element 300. A supply of pressurized oil may be fed into the hydraulic element 300 from an engine lubrication system (not shown) of the engine. The supply of pressurized oil may, as shown in FIG. 3, be fed from the engine lubrication system through an oil feed conduit 308.

Although pressurized oil is described as the exemplary hydraulic fluid in the following discussion, it is understood than any appropriate hydraulic fluid may be fed through the oil feed conduit 308 of the deactivation apparatus and system of the present invention.

A first segment 310 of the oil feed conduit 308 that supplies oil from the engine lubrication system is positioned upstream of an oil feed valve 312. The first segment 310 is shown in dotted lines as it is in the background in this partial cross sectional view. As shown in the embodiment of FIG. 3, oil is fed from the direction of a first position 1 in the first segment 310 toward a second position 2. A second segment 314 of the oil feed conduit 308 is positioned downstream of the oil feed valve 312. The oil feed valve 312 is disposed in a valve channel 316 that has an oil feed inlet that is configured and positioned to receive oil fed from the first segment 310. The valve channel 316 also has an oil feed outlet configured and positioned to feed oil into the second segment 314. In turn, an outlet of the second segment 314 feeds oil into the hydraulic element 300.

The embodiment depicted in FIG. 3 shows the oil feed valve 312 configured in a barbell shape with an aperture or indentation 312A, although other shapes of a valve may be employed. The oil feed valve 312 is configured to move within the channel 316 in, as shown in this depiction, an upward or downward direction. The position of the oil feed valve 312 within the channel 316 is held in response to commands selectively issued by the controller 140 of the engine system, or a component of the control system of the engine such as an engine management system. In response to a command, electronic, mechanical, or hydraulic means actuate the movement of the oil feed valve 312 from one position to another position within the channel 316. The movement of the oil feed valve (upwardly or downwardly in the example shown) positions the aperture or indentation 312A so that the inlet from the first segment 310 leading into the channel 316 is opened or closed.

In the embodiment of FIG. 3, for example, the system is in a condition wherein the command is holding the oil feed valve 312 in a “normal” operating position. In this normal operating position, the valve deactivation system is not engaged. In this normal operating condition, the oil feed valve 312 is positioned in an upper position (designated by upward arrow X) so that the indentation 312A is positioned adjacent to the inlet from the first segment 310. Accordingly, the inlet from first segment 310 is open, and oil may flow into the valve channel 316 (i.e., flow from position 1 into position 2 inside the channel 316).

Also in this open position, the oil also may flow from the channel 316 into the second segment 314 (i.e., from position 2 to position 3). This will complete the oil feed circuit between the first segment 310 and the second segment 314, because the outlet leading from channel 316 to the second segment 314 also is open while the oil feed valve 312 is in its upper position X. In turn, the oil is fed through second segment 314 toward the hydraulic element 300 (i.e., from position 3 to position 4). Thus the oil feed circuit is complete and the oil may be held in this position. In this condition, the pressure of the oil held in the in the oil feed conduit 308 holds the hydraulic element 300 in its expanded state. The expanded state of the hydraulic element 300 thus may be held in the expanded position in a steady state.

The hydraulic element 300 being held in the expanded position causes the pushrod 304 to move with the same or similar magnitude in the same direction (upwardly and downwardly, as depicted in FIG. 3) as the cam follower 302. In turn, the pushrod 304, driven by movement of the cam follower 302, opens and closes the intake valve 208 by moving the valve in and out of its respective seat 209. Thus, the opening and closing of the intake valve 208 is driven according to the lift position of the cam 228, driven by rotation of the camshaft 224.

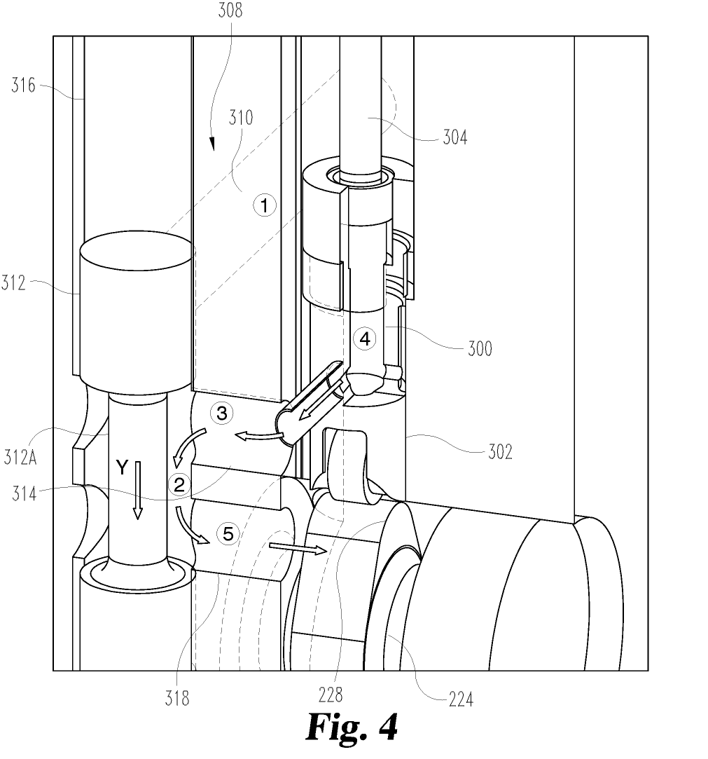

FIG. 4 shows an embodiment as in FIG. 3, but in a condition wherein the valve deactivation system is engaged. Here, in response to detection of a runaway (or overspeed) engine condition, a command signal may be issued by the controller 140 of the engine system, or a component of the control system of the engine such as the engine management system, to engage the valve deactivation system. One or more sensors 170 operatively connected to a controller 140, or other component of a control system of the engine, may be configured to detect an overspeed condition or the presence of one or more combustible components present in the operating environment of the engine. For example, the combustible components may be an uncontrolled fuel present in the ambient air in the operating environment of the engine. Thus the undesired or uncontrolled combustible components may be introduced in intake air entering the engine air intake system. For example, sensors 170 may detect an uncontrolled combustible component, such as a fuel, entering the engine with intake air 118 through the air intake passage 104, and provide signals to the controller 140 indicating the detection of uncontrolled fuel. Hardware or software components of the controller or control system may accordingly issue a signal containing a command to engage the valve deactivation system.

In an exemplary embodiment illustrated by comparing FIG. 3 to FIG. 4, in response to the command to engage the valve deactivation system, electronic, mechanical, or hydraulic means operably connected to the oil feed valve 312 may actuate the movement of the oil feed valve 312 from its normal operating position in the valve channel 316 (the upper position X shown in FIG. 3), to a second position within the channel 316 that stops or slows oil feed to the collapsible element 300. In the example shown in FIG. 4, the oil feed valve 312 has been moved downwardly to a second, lower position designated by arrow Y, relative to its position in FIG. 3. The movement to position Y is made in response to a command to engage the valve deactivation system. In an example, a solenoid element actuates movement of the oil feed valve 312 between positions X and Y.

In the second position Y of the oil feed valve 312 in the valve channel 316 as shown in FIG. 4, the body of the valve 312 blocks feed of oil from position 1 into the valve channel 316, because the indentation 312A is no longer disposed adjacent to the inlet from the first segment 310 that feeds oil into the channel 316. The oil feed circuit is interrupted. Oil from position 4 inside the collapsible element 300 drains through position 3 inside the second segment 314, into a portion of the valve channel 316 at position 2, and in turn, drains toward position 5 within an oil drain passage 318 of the conduit 308. The engaged position of the oil feed valve in the engaged deactivation system permits completion of an oil drain circuit through conduit 308.

In the engaged state of FIG. 4, as oil no longer is fed to, and/or held under pressure within, the collapsible element 300, the element collapses, and so decreases in height (in this view). Due to the collapsed state of the hydraulic element 300, the lift position of the cam 228, driven by rotation of the camshaft 224, no longer drives the cam follower 302. In turn, the pushrod 304 is no longer driven to move upwardly (as depicted) in response to the lift position of the cam 228. Thus, regardless of continued rotation of the camshaft 224, the intake valve 208 is not moved out of its respective seat. Thus, in response to the command to engage the valve deactivation system, the opening of the intake valve 208 is prevented.

It may be appreciated by comparing FIG. 3 to FIG. 4 that the engagement and disengagement of the engine deactivation system is easily reversible, in contrast to prior systems for engine deactivation that require physical resetting of parts, or replacement of spent parts, after an engagement event. After an engagement event, wherein oil feed valve 312 has been moved to its lower position Y, the system may be reset simply by controlling oil feed valve 312 to move it back into its upper, non-engaged position X. Thus the oil circuit in conduit 308 again is completed, and collapsible element 300 may again be expanded because it again is filled with oil held under pressure.

In some embodiments, the collapsible element 300 may be constituted as a hydraulic element. In some embodiments, the collapsible element 300 is constituted as a hydraulic lash adjuster, the general features of which are known in the art.

In the FIGS. 3 and 4 embodiment, the collapsible element 300 is depicted as being positioned in or as a part of the cam follower 302. In another embodiment, the collapsible element 300 may be positioned at or as part of the pushrod 304. The collapsible element 300 may be disposed at a position along a longitudinal axis of the pushrod 304.

In an embodiment, in a case of a pushrod valve train, the deactivation mechanism may comprise an oil-pressure-controlled locking pin mechanism. The operation of the pin may be activated by action of hydraulic fluid such as oil. The activation may move the pin to a position wherein the pin locks movement of the pushrod.

In a number of embodiments of the system, method, and apparatus for engine shutdown to prevent or control an overspeed or runaway engine condition, different known devices for controlling the opening and closing of intake valves 208 and exhaust valves 206 of a valve train system may be employed as or in place of the collapsible element 300 of the embodiments described above. In an embodiment, in a case of a pushrod valve train, the deactivation mechanism may comprise an oil-pressure-controlled locking pin mechanism. The operation of the pin may be activated by action of hydraulic fluid such as oil. The activation may move the pin to a position wherein the pin locks movement of the pushrod. A locking pin may be engaged by action of hydraulic fluid to move to a position to lock movement of the pushrod. In an embodiment, a deactivation mechanism may be disposed at or as a part of the rocker lever portion of a valve train mechanism. In an embodiment, the collapsible element 300 may be disposed at or as a part of a pivot point for a lever or tappet of the valve mechanism. In an embodiment, the valve deactivation apparatus and system may be constituted with, or as, a lost motion linkage. In an embodiment, the valve deactivation apparatus and system may be constituted with an eccentric pivot shaft and actuator. Pertinent known valve controlling mechanisms that may be employed in the engine shutdown control apparatus, system, and method of the instant disclosure are found in U.S. Pat. No. 5,002,022 to Perr; U.S. Pat. No. 6,237,551 to Macor et al.; U.S. Pat. No. 4,892,067 to Paul et al.; U.S. Pat. No. 5,193,494 to Sono et al.; and U.S. Pat. No. 7,201,121 to Weber et al., the contents of each of which is incorporated by reference herein.

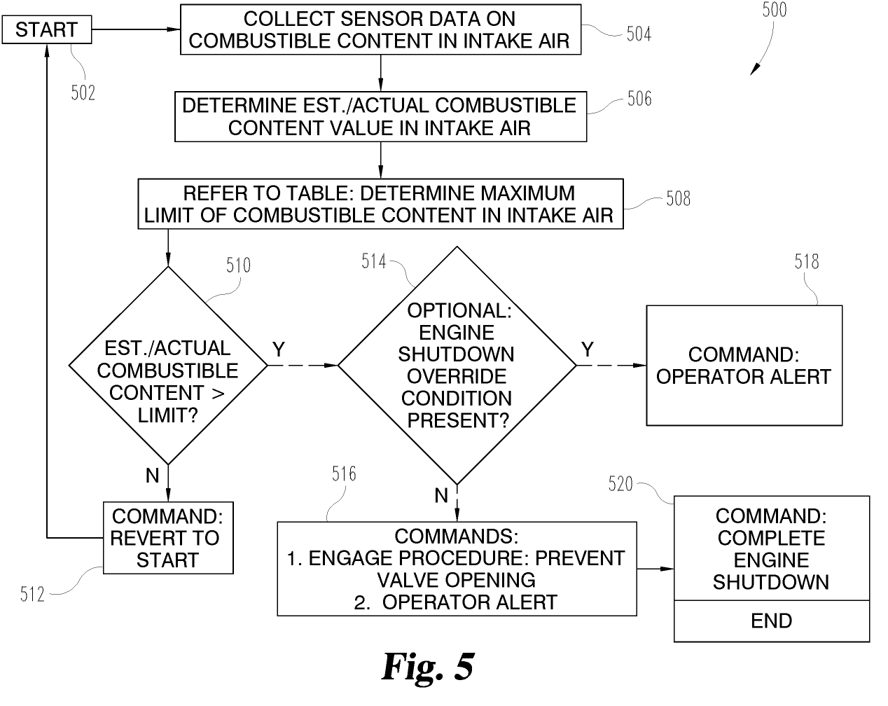

Referring to FIG. 5, a flow diagram of a method or procedure 500 is shown for operating an engine system including an internal combustion engine according to embodiments of the invention. The procedure 500 may conduct engine shutdown control according to an embodiment of the invention to prevent or halt a runaway engine condition. Procedure 500 includes an operation 502 to start the method. The procedure 500 includes an operation 504 to collect data from one or more sensors 170. In embodiments, a processor of the controller 140 may execute instructions to command collection of the data by the sensors 170 on repeated periodic basis, based on a schedule stored in a memory of a component of the controller. The sensors 170 may be adapted to detect one or more combustible or explosive components present in intake air in the intake system at a point upstream of the intake valves 208, such as positions along the intake passage 104 or intake manifold 105. The detection may generate data reflecting detection of actual presence or an estimation of the types of combustible components present in the intake air. The detection may generate data reflecting an actual value and/or an estimation of a percentage of one or more of combustible components present, by volume or mass.

In embodiments, the data reflecting presence of combustible components, and/or an actual determination or estimation of an amount of combustible components present may be interpreted at an operation 506 to determine an estimated or actual value of the content of the one or more combustible components present in the intake air. In an embodiment, the combustible content present may be assessed as a value reflecting a percentage of the total amount of intake air on a by-mass or by-volume basis.

At an operation 508, reference may be made by one or more components of the controller 140 to a memory of the controller 140 to access tables containing stored data reflecting maximum limits of values of content of one or more combustible components present in intake air. The stored data may reflect the maximum permittable values of the content of one or more combustible components present. The stored data may reflect the maximum permittable values of each such component that may be tolerated as a maximum threshold or limit value. The maximum threshold or limit value may be a value set as a value that reflects a level that avoids the danger of runaway engine conditions that could arise out of the presence of an uncontrolled fuel source. The uncontrolled fuel source may supply uncontrolled fuel into the air intake system of the engine and result in an uncontrolled runaway engine condition.

In embodiments of the procedure 500, at conditional operation 510, the procedure 500 determines whether the value for the content of one or more combustible components determined at operation 506 meets or exceeds the stored value of the maximum limit of the combustible component determined at operation 508. If the conditional 510 is NO, the procedure 500 may continue at operation 512 to revert to the START operation 502. The controller 140 may issue an instruction to reiterate the process. The START operation 502 may be conducted and the procedure 500 repeated and reiterated on an automatic or intermittent basis as controlled by the controller 140. In an embodiment, procedure 500 may iterate on the basis of an operator command when an operator may request the procedure to test the operating conditions for possible danger of a runaway engine condition.

If the conditional 510 is YES, the procedure 500 may then continue with the controller issuing a signal including a command to apparatus to prevent an opening of at least one intake valve or exhaust valve of at least one combustion chamber of the engine in response to the amount of the at least one combustible component exceeding the threshold or limit amount. The preventing of the opening thus may prevent or halt a runaway engine condition.

Optionally, if the conditional 510 is YES, the procedure may also continue at conditional operation 514 to determine whether an engine shutdown override condition is present. Operation 514 is an optional step in the procedure 500. In embodiments of the method, one or more engine operating conditions, parameters, or settings may be detected and determined to be present, wherein an engine shutdown due to a potential runaway engine condition should be overridden to satisfy other conditions. For example, an engine operating condition may be present wherein shutdown would cause an additional safety hazard, such as in a moving vehicle in certain traffic conditions, or where demands for engine power from a stationary power generating engine constitute a condition wherein engine shutdown should be overridden to prevent greater hazards. If the conditional operation 514 yields a result of YES, then the procedure may continue at operation 518, wherein one or more components of the controller may optionally generate and communicate to an operator of the system an alert that a potential runaway engine condition has been detected, but that a potential command to institute an engine shutdown procedure has been overridden.

If the conditional operation 514 yields a result of NO, the procedure may continue to operation 516 wherein one or more components of the controller 140 may issue commands to engage the engine shutdown procedure. The shutdown procedure may comprise a valve deactivation procedure to deactivate a valve, for example, as described above with respect to FIGS. 3-4. The valve deactivation procedure may comprise the engagement of a collapsible element 300 to collapse in order to prevent the opening of one or more of the intake valves and/or exhaust valves of one or more of the combustion chambers of the engine. The valve deactivation procedure may, in an embodiment, include an operation 516 of preventing the opening of one or more intake valves or exhaust valves. The operation 516 may include preventing the opening of both the intake valve and the exhaust valve of any one of the combustion chambers of the engine. In an embodiment, the operation 516 may include preventing the opening of both the intake valve and the exhaust valve of a plurality of the combustion chambers of the engine. In another embodiment, the operation 516 may include preventing the opening of both the intake valve and the exhaust valve of all of the combustion chambers of the engine.

In embodiments, the operation 516 also may include an optional operation wherein one or more components of the controller generates and communicates to an operator an alert that a potential runaway engine condition has been detected and the valve deactivation procedure was engaged.

The procedure may continue from operation 516 to an operation 518 wherein the engine shutdown procedure is completed.

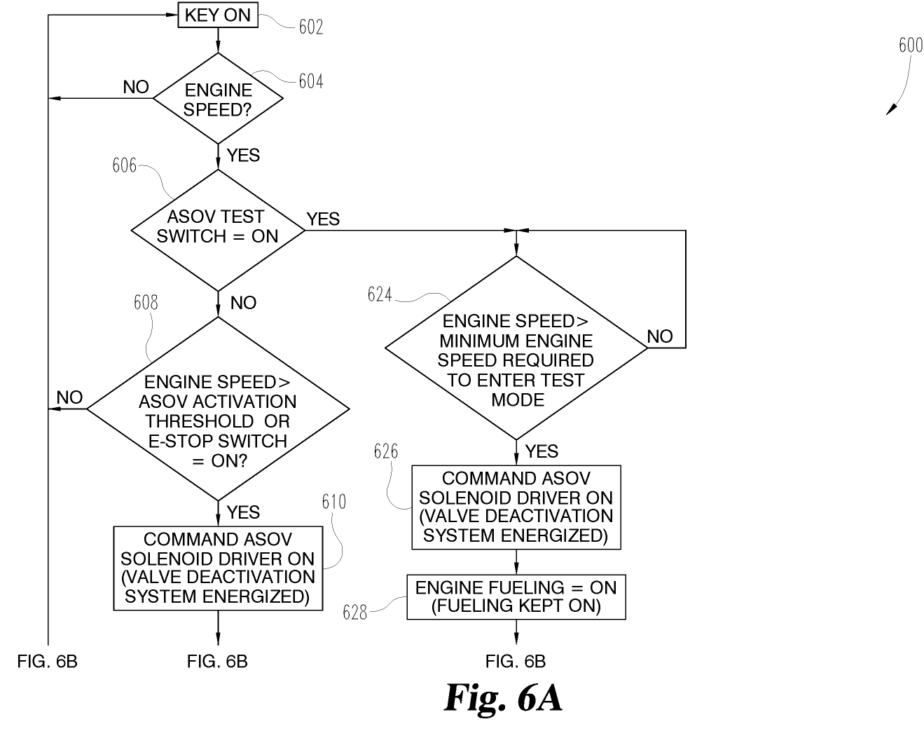

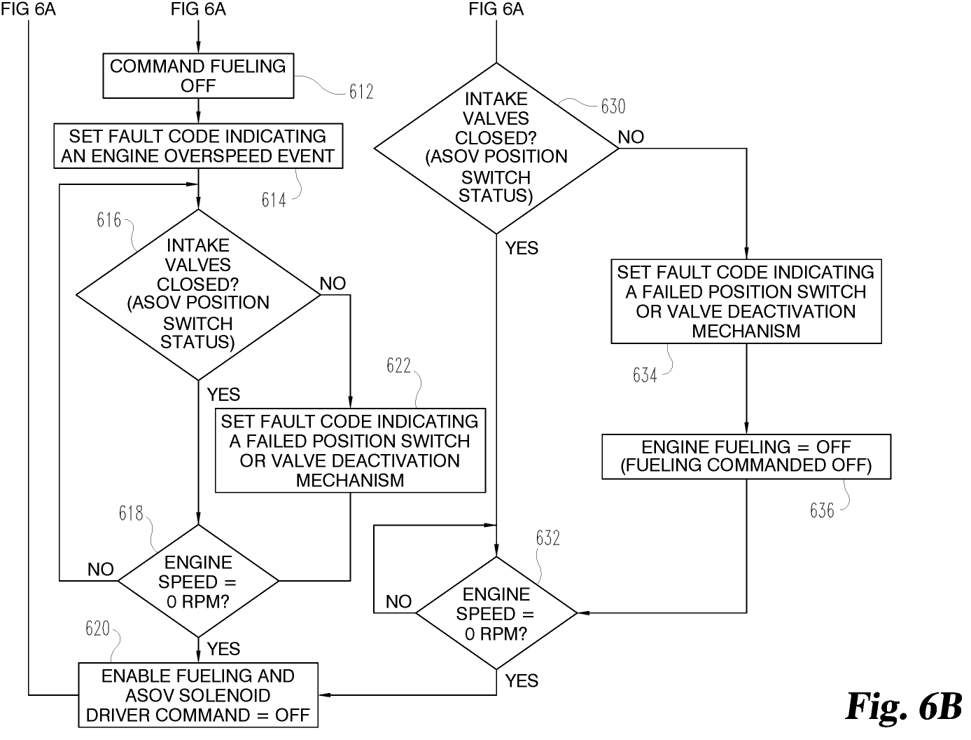

FIGS. 6A-6B depict another flow diagram illustrating certain aspects of an exemplary method according to an aspect of the invention. In particular, FIGS. 6A-6B illustrate a control strategy, method, or procedure 600 for operating an engine system including control of valve deactivation according to embodiments of the invention to prevent or halt a runaway engine condition indicated by an engine overspeed status. The diagram refers to air shut-off valve (ASOV) controls, and in particular to controls for shutting off air intake to at least one combustion chamber of the internal combustion engine in response to engine conditions that may indicate a runaway engine condition.

As shown in FIG. 6A, the procedure or control strategy 600 includes an operation 602 to start the control strategy by activating the engine system by keying the engine on (Key ON).

At conditional operation 604, a determination is made on whether the engine has started. If the result of the conditional is no, the strategy reverts to operation 602. If the result of the conditional is yes, the strategy proceeds to operation 606.

At conditional operation 606, a determination is made on whether the air shut-off valve (ASOV) test switch is on (= ON). If the result of the conditional is no, the strategy proceeds to operation 608. If the result of the conditional is yes, the strategy proceeds to operation 624 to conduct a test mode.

At conditional operation 608, a determination is made on whether the engine operating speed exceeds a threshold for air shut-off valve activation, and/or whether a control signal has been issued commanding an emergency stop of the engine. In an example, the engine system controller may sense an engine operating speed that exceeds the threshold, tending to indicate an engine runaway condition or overspeed condition that should be controlled. In an example, an operator of the engine system may command an emergency stop (E-Stop) by activating a switch or button (E-Stop Switch = ON) in response to finding an engine overspeed situation. If the result of the conditional 608 is no, the strategy reverts to operation 602. If the result of the conditional is yes, the strategy proceeds to operation 610.

At operation 610, the valve deactivation system may be energized. In an embodiment, the air shut-off may be actuated by a solenoid driver. The controller 140 or a unit of the controller 140 may send an output signal via a driver to a solenoid or relay that, in turn, will actuate the air shut-off system (Command ASOV Solenoid Driver ON). The control strategy for the ASOV feature thus may detect one or more specific engine conditions, and may send an output signal to a solenoid or relay that will trigger the valve deactivation system.

At operation 612 (see FIG. 6B), the controller may issue a command to an actuator for fuel supply to combustion chambers to be shut down (Command Fueling OFF). ASOV controls may incorporate fuel shutdown capability as part of the engine shutdown process by simultaneously activating the fuel shutoff valve whenever the valve deactivation system is engaged.

At operation 614, a fault code may be set, indicating an engine overspeed event (runaway engine condition) has occurred. The fault code may be stored in a memory of the controller and/or communicated to a remote control system as part of an on-board diagnostics record or control system, and/or activate an alert to an operator such as a visual or sound alert or alarm. A feedback position switch may be employed to indicate the state of the valve deactivation system and/or the solenoid output state.

At conditional operation 616, a determination is made on whether the air intake valve of the respective combustion chamber has been closed. The determination reflects the ASOV position switch status. If the result of the conditional is no, the strategy proceeds to operation 622. If the result of the conditional is yes, the strategy proceeds to operation 618.

At operation 622, a fault code is set indicating a failed position switch or a failed valve deactivation mechanism. The fault code may be stored in a memory of the controller and/or communicated to a remote control system as part of an on-board diagnostics record or control system, and/or activate an alert to an operator such as a visual or sound alert or alarm. The strategy then proceeds to operation 618.

At conditional operation 618, a determination is made on whether the engine speed is zero RPM (revolutions per minute). If the result of the conditional is no, the strategy reverts to operation 616. If the result of the conditional is yes, the engine speed shutdown has been accomplished (speed = 0 rpm) and then the strategy proceeds to operation 620.

At operation 620 (see FIG. 6B), the engine may be re-set to restart after the shutdown event. Fueling is enabled, and the ASOV solenoid driver command actuating the ASOV system is set to OFF. Then the strategy may revert to the starting point, Key ON at operation 602.

As shown in FIG. 6A, when the result of the conditional operation 606 is yes, the strategy may proceed to conditional operation 624. At conditional operation 624, a determination is made on whether the engine speed exceeds a minimum engine speed required to enter a test mode of the ASOV system. If the result of the conditional is no, the strategy reverts to operation 624, to iterate re-checking for reaching of the minimum engine speed to conduct the test mode. If the result of the conditional is yes, the strategy proceeds to operation 626.

At operation 626, a test mode is entered, and the valve deactivation system may be energized. In an embodiment, the controller 140 or a unit of the controller 140 may send an output signal via a driver to a solenoid or relay that, in turn, will actuate the air shut-off system (Command ASOV Solenoid Driver ON).

At operation 628, a signal may be sent including a command to set engine fueling to ON (Fueling kept ON) during the test mode.

At conditional operation 630 (see FIG. 6B), a determination is made on whether the air intake valves are closed (ASOV Position Switch status). If the result of the conditional is no, the strategy proceeds to operation 634. If the result of the conditional 630 is yes, the strategy proceeds to operation 632.

At operation 634, a fault code may be set indicating a failed position switch or a failed valve deactivation mechanism. The fault code may be stored in a memory of the controller and/or communicated to a remote control system as part of an on-board diagnostics record or control system, and/or activate an alert to an operator such as a visual or sound alert or alarm. The strategy then proceeds to operation 636.

At operation 636, a command is sent to command engine fueling OFF (Fueling commanded OFF). The strategy proceeds to operation 632.

At operation 632, a determination is made on whether the engine speed is zero RPM (revolutions per minute). If the result of the conditional is no, the strategy reverts to operation 632 to iterate until the condition is met. If the result of the conditional is yes, the engine speed shutdown test mode has been completed (speed = 0 rpm), and then the strategy proceeds to operation 620.

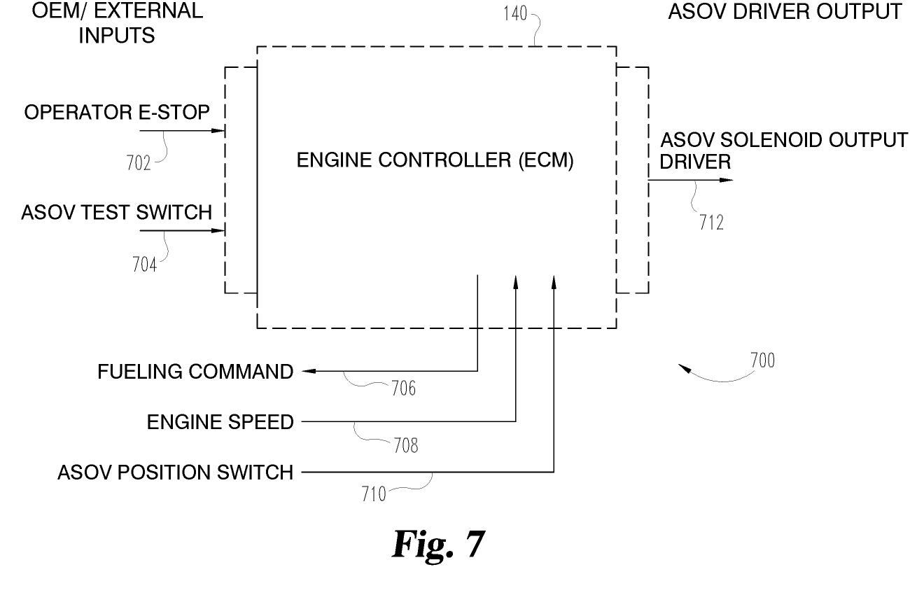

FIG. 7 is a schematic diagram illustrating certain aspects of a control system and method for air shut-off valve (ASOV) control according to an aspect of the invention. In particular, the figure shows the pathways for inputs to and outputs from a control system of the engine system, which may include controller 140 or units thereof.

Input 702 is an input signal to the control system comprising an operator E-stop or emergency stop directive. The E-Stop feature allows original equipment manufacturer (OEM) features, controls or settings, and/or optionally, the operator, to directly activate the ASOV solenoid output driver in the event of an emergency. The controller monitors E-Stop input, and when that input is in an ON status, the controller will activate the solenoid driver to engage the valve deactivating mechanism. When E-Stop input is active, the input will also disable fueling in addition to closing the ASOV.

Input 704 may comprise a directive activated by an ASOV test switch to enter a test mode of the ASOV control system, and optionally may be generated by original equipment manufacturer (OEM) features, controls or settings. The input 704 feature allows the OEM controls and/or the operator to perform ASOV system tests on command to check the integrity of the ASOV system. In an embodiment, the controller will reduce the engine overspeed threshold to a much lower value (typically just above low idle) if the ASOV test switch is activated. In an embodiment, the operator may then increase engine speed to simulate an engine runaway condition and verify the activation of ASOV system.

Output 706 is an output command signal from the controller, made in response to received inputs indicating an overspeed event is occurring. For example, the input may indicate an overspeed threshold (rpm) has been exceeded. Output 706 may command fueling actuators in the engine system to control fueling of one or more combustion chambers of the engine. When the ASOV system is activated (either by an operator E-Stop or by an engine runaway condition), the controller will disable engine fueling in addition to closing the valves. However, an exception may apply when the ASOV Test Switch is ON, in which status the fueling command will be kept ON when ASOV is activated to check the integrity of the ASOV system.

Input 708 is an input to the control system comprising information on the engine speed (rpm) which may be generated by a detector. The engine overspeed condition may be caused by an intake air composition that includes uncontrolled intake of combustible components in the intake air that are combusted in a runaway engine condition.

Input 710 is an input to the control system comprising information on the status of the ASOV position switch which may be determined by sensors detecting switch status. The ASOV position switch confirms the position of the valve deactivation mechanism when such has been commanded by the controller to open or to close. In a condition wherein the ASOV solenoid is activated, the position switch will be monitored by the controller to verify that the ASOV solenoid changes the output state accordingly.

Output 712 is an output signal from the control system to a driver or other actuating system that may comprise a command to a driver or other actuator of the valve deactivation system. The command may trigger a command to a driver to actuate an ASOV solenoid to achieve air shut-off. In an embodiment, the solenoid driver output will be a 24 VDC high side driver output signal capable of driving the valve deactivation mechanism. In an embodiment, the solenoid driver output will have an adjustable duty cycle (ON vs OFF time) to aid maintenance efficiency.

As evident from the above discussion, in certain embodiments, the apparatus or system 100 may include a controller 140 and/or the method may conducted utilizing a controller structured to perform certain operations to control operations of engine 102. In some embodiments, a controller may be constituted as an electronic engine control module (ECM) of an engine system. In certain embodiments, the controller 140 may comprise a processor. The controller or units thereof may receive and process inputs and issue outputs in output signals. The system or apparatus may comprise a communication interface between the controller and an actuator for controlling operation of at least one intake valve or exhaust valve. The system or apparatus may comprise at least one non-transitory computer readable medium configured to store instructions executable by the controller to evaluate a detected amount of at least one combustible component of intake air entering an air intake system of the engine. The medium may be configured to store instructions executable by the controller to control operation of actuator in response to the detected amount exceeding a threshold amount. The medium may be configured to store instructions executable by the controller to override, in response to one or more engine operating conditions, the instruction to control operation of the actuator. The at least one combustible component may be detected by a sensor disposed in the air intake system.

As evident from the above discussion, in certain embodiments, the controller may form a portion of a processing subsystem including one or more computing devices having memory, processing, and communication hardware. The controller 140 may be a single device or a distributed device, and the functions of the controller 140 may be performed by hardware or instructions encoded on a computer readable medium that is non-transitory. The controller 140 may be included within, partially included within, or completely separated from an engine controller (not shown). The controller 140 is in communication with any sensor or actuator throughout the system 100, such as engine sensors 170 and intake valve and exhaust valve actuators, including through direct communication, communication over a datalink, and/or through communication with other controllers or portions of the processing subsystem that provide sensor and/or actuator information to the controller 140.

In certain embodiments, the controller 140 may functionally execute certain operations. The descriptions herein including the controller operations emphasizes the structural independence of the controller, and illustrates one grouping of operations and responsibilities of the controller. Other groupings that execute similar overall operations are understood within the scope of the present application. Aspects of the controller may be implemented in hardware and/or by a computer executing instructions stored in non-transient memory on one or more computer readable media, and the controller may be distributed across various hardware or computer based components.

Example and non-limiting controller implementation elements include sensors 170 providing any value determined herein, sensors 170 providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements. For example, controller implementation elements may include sensors 170 providing values indicating a condition in which fuel is detected in intake air entering the engine system. Values may indicate a condition in which fuel detected in the intake air entering the engine system is entering in an uncontrolled state, such as fuel that is a component of ambient air in the environment in which the engine is operating.

The listing herein of specific implementation elements is not limiting, and any implementation element for any controller described herein that would be understood by one of skill in the art is contemplated herein. The controllers herein, once the operations are described, are capable of numerous hardware and/or computer based implementations, many of the specific implementations of which involve mechanical steps for one of skill in the art having the benefit of the disclosures herein and the understanding of the operations of the controllers provided by the present disclosure.

Certain operations described herein include operations to interpret or determine one or more parameters. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a software parameter indicative of the value, reading the value from a memory location on a non-transient computer readable storage medium, receiving the value as a run-time parameter by any means known in the art, and/or by receiving a value by which the interpreted parameter may be calculated, and/or by referencing a default value that is interpreted to be the parameter value.

Disclosed is a method for operating an engine system including an internal combustion engine, comprising: determining that intake air entering the engine includes at least one combustible component in an amount exceeding a combustible component threshold; preventing an opening of at least one intake valve or exhaust valve of at least one combustion chamber of the engine in response to the at least one combustible component exceeding the threshold. In embodiments of the foregoing, the preventing the opening step prevents or halts a runaway engine condition. In embodiments of any of the foregoing, preventing the opening step comprises preventing opening of the intake valve and the exhaust valve of at least one combustion chamber; a plurality of combustion chambers; and/or all of the combustion chambers of the engine. In embodiments of any of the foregoing, the source of the at least one combustible component in the intake air is an ambient uncontrolled fuel source. In embodiments of any of the foregoing, the determining step comprises detecting the at least one combustible component with a sensor disposed in an intake system of the engine. In embodiments of any of the foregoing, there may further be included a step of overriding the preventing step in response to one or more engine operating conditions.

Also disclosed, separately or in combination with any of the foregoing, is an engine system comprising an internal combustion engine comprising an air intake system supplying intake air to at least one combustion chamber of the engine for combustion of a fuel; and a controller in operative communication with an actuator of at least one intake valve or exhaust valve of the combustion chamber, wherein the controller is configured to automatically control the actuator to prevent an opening of the valve in response to detection of at least one combustible component in the intake air in an amount exceeding a combustible component threshold. In embodiments of any of the foregoing, the system includes a sensor disposed in the air intake system that detects the combustible component in the intake air.

Also disclosed, separately or in combination with any of the foregoing, is an internal combustion engine system comprising a device for deactivating a valve of a combustion chamber of the engine in response to a signal from a controller of the system indicating presence of at least one combustible component in intake air supplied to the combustion chamber in an amount that exceeds a combustible component threshold. In embodiments of any of the foregoing, the device for deactivating the valve comprises a collapsible element disposed to prevent opening of the valve. In embodiments of any of the foregoing, the valve is an intake valve or is an exhaust valve. In embodiments of any of the foregoing, the collapsible element is a hydraulic element.

Also disclosed, separately or in combination with any of the foregoing, is an apparatus for controlling operation of an internal combustion engine comprising a controller; a communication interface between the controller and an actuator for controlling operation of at least one intake valve or exhaust valve of a combustion chamber of the engine; and at least one non-transitory computer readable medium configured to store instructions executable by the controller to evaluate a detected amount of at least one combustible component of intake air entering an air intake system of the engine and to control operation of the actuator in response to the detected amount exceeding a threshold amount. In embodiments of any of the foregoing, the at least one combustible component is detected by a sensor disposed in the air intake system. In embodiments of any of the foregoing, operation of the actuator prevents opening of at least one intake valve. In embodiments of any of the foregoing, operation of the actuator prevents opening of the intake valve and the exhaust valve of at least one combustion chamber. In embodiments of any of the foregoing, operation of the actuator prevents opening of the intake valve and the exhaust valve of a plurality of combustion chambers of the engine. In embodiments of any of the foregoing, operation of the actuator prevents opening of the intake valve and the exhaust valve of all combustion chambers of the engine. In embodiments of any of the foregoing, the medium is configured to store instructions executable by the controller to override, in response to one or more engine operating conditions, the instruction to control operation of the actuator.

Also disclosed, separately or in combination with any of the foregoing, is a method for operating an engine system including an internal combustion engine, comprising determining that engine speed exceeds a threshold indicating an engine overspeed condition; preventing an opening of at least one intake valve or exhaust valve of at least one combustion chamber of the engine in response to the engine speed exceeding the threshold.

Also disclosed, separately or in combination with any of the foregoing, is an engine system comprising an internal combustion engine comprising an air intake system supplying intake air to at least one combustion chamber of the engine for combustion of a fuel; and a controller in operative communication with an actuator of at least one intake valve or exhaust valve of the combustion chamber, wherein the controller is configured to automatically control the actuator to prevent an opening of the valve in response to detection of an engine speed exceeding an engine speed threshold indicating an engine overspeed condition.

Also disclosed, separately or in combination with any of the foregoing, is an apparatus for controlling operation of an internal combustion engine comprising a controller; a communication interface between the controller and an actuator for controlling operation of at least one intake valve or exhaust valve of a combustion chamber of the engine; and at least one non-transitory computer readable medium configured to store instructions executable by the controller to evaluate a detected engine speed, and to control operation of the actuator in response to the detected engine speed exceeding a threshold amount indicating an engine overspeed condition.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item may include a portion and/or the entire item unless specifically stated to the contrary.

One of skill in the art may appreciate from the foregoing that unexpected benefits are derived from application of the method, system, and apparatus to the problem of preventing or stopping a runaway engine condition, without the need for additional components or parts, or changes in the configuration of a conventional engine or its features. Additional components and parts, and changes to configuration of a conventional engine system may add costs and complexity to manufacture, operation, and maintenance of the engine system. A key benefit contemplated by the inventors is control of a runaway engine condition in a system, method, or apparatus, while excluding any additional components, steps, or change in structural features. In this exclusion, maximum efficiency of operation and cost containment may be effected. Accordingly, the substantial benefits of simplicity of manufacture, operation, and maintenance of standard or conventionally produced engines as to which the method and system may be applied may reside in an embodiment of the invention consisting of, or consisting essentially of, the method, system, or apparatus disclosed herein. Thus, embodiments of the invention contemplate the exclusion of steps, features, parts, and components beyond those set forth herein, and contemplate, in some embodiments, the exclusion of certain steps, features, parts, and components that are set forth in other parts of this disclosure.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

1. A method for operating an engine system including an internal combustion engine, comprising:
determining that intake air entering the engine includes at least one combustible component in an amount exceeding a combustible component threshold;
preventing an opening of at least one intake valve or exhaust valve of at least one combustion chamber of the engine in response to the at least one combustible component exceeding the threshold.

2. The method of claim 1, wherein preventing the opening prevents or halts a runaway engine condition.

3. The method of claim 1, wherein preventing the opening comprises preventing opening of the intake valve and the exhaust valve of at least one combustion chamber.

4. The method of claim 1, wherein preventing the opening comprises preventing opening of the intake valve and the exhaust valve of a plurality of combustion chambers of the engine.

5. The method of claim 1, wherein preventing the opening comprises preventing opening of the intake valve and the exhaust valve of all combustion chambers of the engine.

6. The method of claim 1, wherein a source of the at least one combustible component in the intake air is an ambient uncontrolled fuel source.

7. The method of claim 1, wherein the determining step comprises detecting the at least one combustible component with a sensor disposed in an intake system of the engine.

8. The method of claim 1, further comprising overriding the preventing step in response to one or more engine operating conditions.

9. The system according to claim 11, further comprising:
an internal combustion engine comprising an air intake system supplying intake air to at least one combustion chamber of the engine for combustion of a fuel; and
the controller in operative communication with an actuator of at least one intake valve or exhaust valve of the combustion chamber,
wherein the controller is configured to automatically control the actuator to prevent an opening of the valve in response to detection of the at least one combustible component in the intake air in the amount exceeding the combustible component threshold.

10. The system of claim 9, comprising a sensor disposed in the air intake system that detects the combustible component in the intake air.

11. An internal combustion engine system comprising:
a device for deactivating a valve of a combustion chamber of the engine in response to a signal from a controller of the system indicating presence of at least one combustible component in intake air supplied to the combustion chamber in an amount that exceeds a combustible component threshold.

12. The system according to claim 11, wherein the device for deactivating the valve comprises a collapsible element disposed to prevent opening of the valve.

13. The system according to claim 11, wherein the valve is an intake valve or an exhaust valve.

14. (canceled)

15. The system according to claim 11, wherein the collapsible element is a hydraulic element.

16. An apparatus for controlling operation of an internal combustion engine comprising:
a controller;
a communication interface between the controller and an actuator for controlling operation of at least one intake valve or exhaust valve of a combustion chamber of the engine; and
at least one non-transitory computer readable medium configured to store instructions executable by the controller
to evaluate a detected amount of at least one combustible component of intake air entering an air intake system of the engine and
to control operation of the actuator in response to the detected amount exceeding a threshold amount.

17. The apparatus of claim 16, wherein the at least one combustible component is detected by a sensor disposed in the air intake system.

18. The apparatus of claim 16, wherein operation of the actuator prevents opening of at least one intake valve.

19. The apparatus of claim 16, wherein operation of the actuator prevents opening of the intake valve and the exhaust valve of at least one combustion chamber.

20. (canceled)

21. The apparatus of claim 16, wherein operation of the actuator prevents opening of the intake valve and the exhaust valve of all combustion chambers of the engine.

22. The apparatus of claim 16, wherein the medium is configured to store instructions executable by the controller to override, in response to one or more engine operating conditions, the instruction to control operation of the actuator.

23-25. (canceled)
